(19) United States
(12) Patent Application Publication
(10) Pub. No.: US 2008/0192776 A1
(43) Pub. Date: Aug. 14, 2008

(54) Mechanism for increasing UWB MAC efficiency and bandwidth via the period inclusion of PHY preambles for synchronization

(76) Inventors: Kristoffer D. Fleming, Chandler, AZ (US); David G. Leeper, Scottsdale, AZ (US)

Correspondence Address: INTEL CORPORATION;c/o INTELLEVATE, LLC, P.O. BOX 52050, MINNEAPOLIS, MN, 55402, US

(21) Appl. No.: 11/704,524

(22) Filed: Feb. 9, 2007

(51) Int. Cl. H04J 3/06

(52) U.S. Cl. 370/514; 370/476

(57) ABSTRACT

A wireless device may select shorter preambles that enable the use of a newly defined Zero Length Inter-Frame Space (ZIFS). The shortened or zero length preambles may be inserted into a Physical Layer Convergence Protocol (PLCP) preamble as determined by the PHY while maintaining packet/frame synchronization.

Developments in a number of different digital technologies have greatly increased the need to transfer data from one device across a network to another system. Technological developments permit digitization and compression of large amounts of voice, video, imaging, and data information, which may be transmitted from laptops and other digital equipment to other devices within the network. These developments in digital technology have stimulated a need to deliver and supply data to these processing units.

With the amounts of data that devices transmit in a wireless network, enhancements to applications promote migrating to higher bit rates in packet switched schemes to handle the higher data volume. One notable issue that needs resolution involves the coordination of higher transmission speeds without a drop in efficiency due to fixed, unchangeable preamble formats, protocols, and/or packet lengths. The loss of efficiency may waste a large part of the benefit of an increased link speed. Therefore, improved circuits and improved methods are needed to increase the efficiency of transmissions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a prior art diagram that illustrates a WiMedia v1.1 PHY & MAC Frame Format;

FIG. 2 is a prior art diagram that illustrates inter-frame spacings defined as Short Inter-Frame Space (SIFS) and Minimum Inter-Frame Space (MIFS);

FIG. 3 is a diagram that illustrates changes in the PHY frame formats and inter-frame spacing to improve the performance and efficiency of the MAC in accordance with the present invention; and

FIG. 4 is a diagram that illustrates three new preambles in accordance with the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Designed as a cable replacement technology, Wireless Personal Area Networks (WPANs) cover personal work spaces to provide freedom from cables when performing tasks that synchronize data or share files between devices. The WPAN network uses technology that permits communication within a short range, typically using the worldwide 2.4 GHz ISM band as the frequency of interest because of its general availability worldwide and its suitability to low cost radio solutions.

The standards activity of WPANs in IEEE 802.15 has been responsible for creating a variety of WPAN standards. For instance, the IEEE 802.15.1 task group forged the standard based on Bluetooth that uses a short-range radio link (up to 10 meters) to transmit data between personal devices, forming an ad-hoc network. Further, the standardization efforts of Ultra-Wideband (UWB) in IEEE 802.15.3a is an emerging technology that provides a high rate WPAN, low power alternative to the wireless networks such as Bluetooth. UWB is positioned to become a major factor in Personal Area Networks for providing multimedia electronic devices with wireless streaming media. As such, UWB offers peer-to-peer and ad-hoc networking that allows devices to connect directly to each other and permits devices to roam and create connections among devices in that area or the internet.

The present invention may facilitate applications using higher resolution displays, better image capturing cameras, more storage capability, and new applications for mobile video. As such, the present invention may be used in a variety of products with the claimed subject matter incorporated into desktop computers, laptops, smart phones, MP3 players, cameras, communicators and Personal Digital Assistants (PDAs), medical or biotech equipment, automotive safety and protective equipment, automotive infotainment products, etc. However, it should be understood that the scope of the present invention is not limited to these examples.

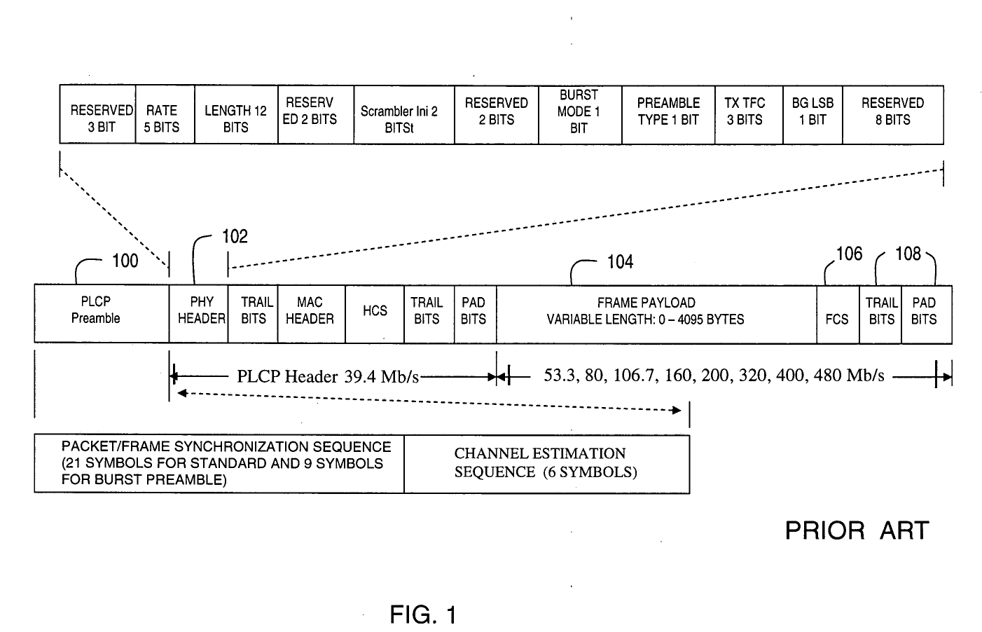

FIG. 1 is a prior art diagram that illustrates a WiMedia v1.1 PHY & MAC Frame Format established for coexistence between devices operating in a WLAN and WPAN network. WiMedia Media Access Control Specification (MAC) support the simultaneous use of multiple protocols such as, for example, IP networking, Wireless USB™, Wireless 1394™, Bluetooth™, and other protocols that may operate over the UWB PHY. Whereas the first generation of WiMedia MAC & PHY operates at 480 Mbps and achieved an efficiency of approximately 85%, the second generation may operate at data rates of 960, 1920 or 3840 Mbps. For applications using the second generation at these increased PHY data rates, the overall MAC efficiency drops to about 69%.

UWB currently operates over portions of the 3.1-10.7 GHz frequency band. Regulations vary slightly from country to country, but in the United States UWB operation is governed by FCC Rules & Regulations Part 15.501 to 15.525. UWB sends low power signals over frequency spans of 500 MHz or more to support selectable data rates. Details of the WiMedia form of UWB may be found in the Ecma-368 Specification.

The frame illustrated in the figure shows a Physical Layer Convergence Protocol (PLCP) Preamble 100, a PLCP Header 102, a Frame Payload 104, a Frame Check Sequence (FCS) 106, and Tail & Pad bits 108. The PLCP Preamble 100 consists of three sequences shown in the figure as Packet, Frame, and Channel Estimation sequences. The specification defines two PLCP Preambles for the Packet Synchronization Sequence, the Standard Preamble having 21 symbols and the Burst Preamble having 9 symbols.

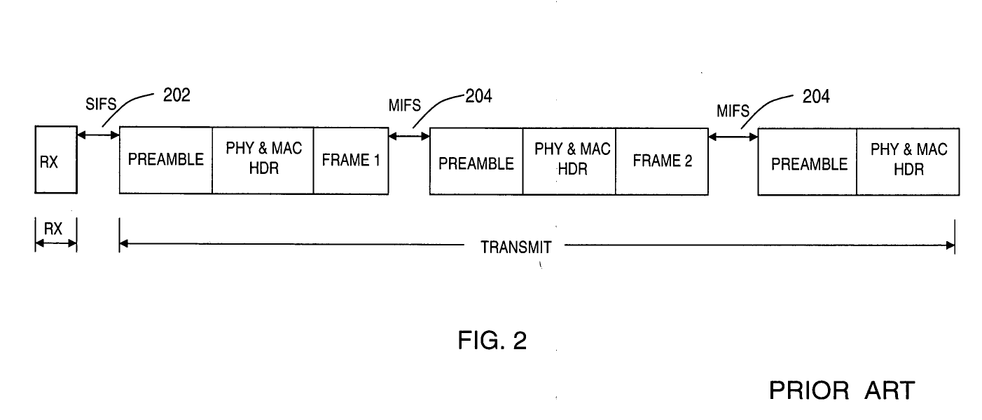

FIG. 2 is a prior art diagram that illustrates packets put into data frames and the inter-frame spacings that separate the frames. Each packet is put into a data frame that consists of a Physical Layer Convergence Protocol (PLCP) preamble. The PLCP includes a PHY header, where the PLCP data field carries the MAC frame which includes a MAC header, the data packet itself and a frame check sequence (FCS). Each frame receives a positive acknowledgement that consists of the following components: a Short Inter-Frame Space (SIFS) 202 or a Minimum Inter-Frame Space (MIFS) 204; the PLCP preamble, the PLCP header and the acknowledgement data transmitted at the rate coded in the PLCP.

Each frame is separated from the preceding frame by an inter-frame spacing. The WiMedia PHY & MAC version 1.0 specification defines the inter-frame spacing to be 10 microseconds for Short Inter-Frame Space (SIFS) and 1.875 microseconds for Minimum Inter-Frame Space (MIFS). The SIFS provides transceivers time to turn around and time for a device having priority to receive access to the wireless medium. The MIFS indicates that none of the devices needs to change RX and TX states.

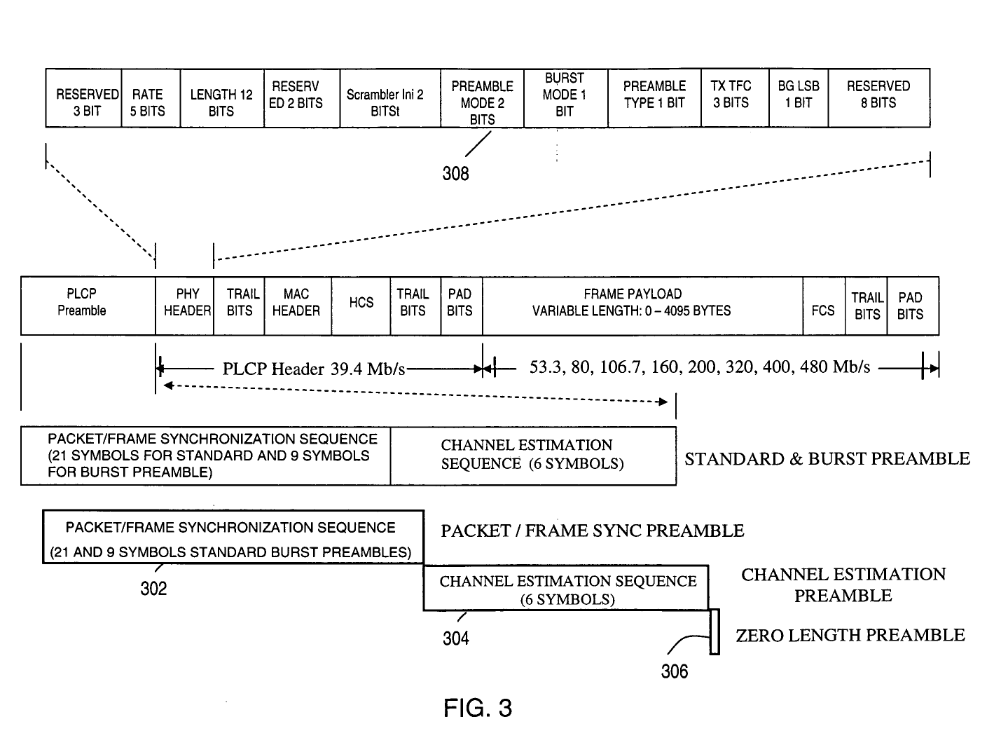

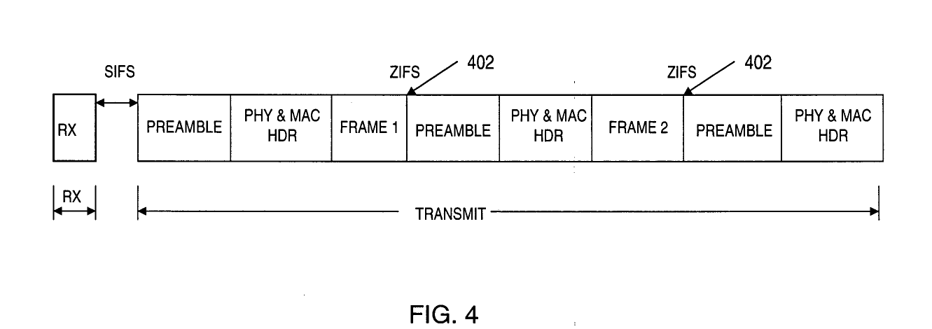

FIGS. 3 and 4 illustrate changes made to the PHY frame formats and to the inter-frame spacings in accordance with the present invention to improve the performance and efficiency of the MAC. Devices that support the 1.0 version of the standard may still function with the newer wireless communication devices that use the illustrated frame formats and inter-frame spacings in accordance with embodiments of the present invention and communicate over-the-air with other devices that operate in WPAN and/or UWB networks.

First, note in FIG. 3 that three new preambles are defined, the Packet/Frame Synchronization only preamble 302, the Channel Estimation only preamble 304, and the Zero Length preamble 306. Thus, a determination is made for the frame to contain one of the preambles labeled as preamble 302, preamble 304 or preamble 306 in the Physical Layer Convergence Protocol (PLCP) preamble. Also in accordance with the present invention, a new Preamble Mode field 308 in the PHY header is defined and indicates which preamble type was selected to be used in the following packet.

Second, shortened or zero length preambles (preamble 304 and/or preamble 306) are inserted into the PLCP as often as possible as determined by the PHY maintaining packet/frame synchronization. With the current WiMedia UWB PHY, channel synchronization is maintained by continuous synchronization on each symbol while the device is receiving, and therefore, the present invention provides an advantage over the prior art by using the shortened or zero length preambles for several consecutive frames instead of the standard preamble or the burst preamble.

An algorithm executing within the wireless device monitors the data transmitted over the channels in the network to determine that synchronization has been maintained. Based on the results of the algorithm, an appropriate preamble 302, preamble 304 or preamble 306 may be selected for each frame to maintain continuous synchronization on each symbol while the device is receiving. By way of example, the preamble 304 (the channel estimation preamble and six symbols in length) or the preamble 306 (the zero length preamble and zero symbols in length) may be used for several packets, and then, in order to maintain synchronization the standard or burst preamble 302 may be selected and used to allow other devices which are not continuously receiving to re-synchronize. Link Feedback IE may be used by the other device(s) to indicate to the transmitter that their receiver(s) need the longer preambles or that the longer preambles need to be selected more often to remain synchronized.

Note that the selection and insertion of the shorter preambles, i.e., preambles 304 and 306, enables the frequent use of the newly defined zero length inter-frame space ZIFS 402 as shown in FIG. 4. The newly defined inter-frame spacing shown in the figure as Zero Inter-Frame Space (ZIFS) 402 is defined to be zero microseconds (0 symbols) in accordance with the present invention. The embodiment illustrated in the figure that utilizes the three preambles and the ZIFS spacing increases the MAC efficiency from 69% to 85% for data rates of 960 Mbps. Similar improvements also increase the MAC efficiency at the higher PHY data rates.

By now it should be apparent that embodiments of the present invention allow increased efficiencies and additional data rate performance for radio devices using the present invention. Radio systems may be collocated in the platform of a communications device, use the illustrated PHY frame formats and inter-frame spacings and provide the capability of communicating in an RF/location space with other devices in a WPAN network or a UWB network.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A preamble format, comprising:
a preamble mode field in a PHY header to indicate a preamble type to be inserted in a Physical Layer Convergence Protocol (PLCP) preamble and used to transmit a following frame.

2. The preamble format of claim 1 wherein the preamble mode field further includes:
storage data bits to select the preamble type for a Wireless Personal Area Network (WPAN) or an Ultra-Wideband (UWB) network, wherein the preamble type is selected from a preamble having 21 symbols and at least two other preambles each having less than 21 symbols.

3. The preamble format of claim 2 wherein the at least two other preambles include a channel estimation preamble having six symbols and a zero length preamble having zero symbols.

4. The preamble format of claim 3 further comprising:
a Zero Length Inter-Frame Space (ZIFS) that is zero symbols and inserted between frames when either the channel estimation preamble or the zero length preamble is selected for the PLCP preamble.

5. A method of communication by a device, comprising:
monitoring data in a communication channel to determine synchronization; and
selecting a type of preamble from among at least two preambles to insert in a following frame transmitted by the device based on the synchronization.

6. The method of claim 5 wherein selecting the type of preamble further includes:
selecting an appropriate preamble for each frame to maintain continuous synchronization on each symbol while the device is receiving packet data.

7. The method of claim 5 wherein selecting the type of preamble further includes:
selecting a channel estimation preamble having six symbols or a zero length preamble having zero symbols when the device is in synchronization.

8. The method of claim 7 wherein selecting the type of preamble further includes:
inserting a Zero Length Inter-Frame Space (ZIFS) having zero microseconds and zero symbols to separate frames when a channel estimation preamble having six symbols or a zero length preamble having zero symbols is selected.

9. The method of claim 5 wherein selecting the type of preamble further includes:
selecting a standard or burst preamble having twenty one symbols to allow other devices which are not continuously receiving to re-synchronize.

10. The method of claim 5 wherein selecting the type of preamble further includes:
transmitting a preamble mode field in a PHY header to indicate a preamble type to be inserted in a Physical Layer Convergence Protocol (PLCP) preamble in a following frame.

11. The method of claim 5 further including:
receiving from other devices a Link Feedback IE to indicate to the transmitter of the device to select longer preambles to remain synchronized.

12. A method to dynamically adapt a preamble format by a device, comprising:
monitoring synchronization on each symbol while the device is receiving data;
selecting a preamble type from a group of preamble types for each frame to maintain continuous synchronization; and
providing a preamble mode field in a PHY header to indicate the preamble type to be inserted in a Physical Layer Convergence Protocol (PLCP) preamble and used to transmit a following frame by the device.

13. The method of claim 12 further including:
selecting a channel estimation preamble having six symbols or a zero length preamble having zero symbols from the group of preamble types for several consecutive frames.

14. The method of claim 13 further including:
using a Zero Length Inter-Frame Space (ZIFS) having zero microseconds and zero symbols to separate frames when the PLCP preamble includes the channel estimation preamble having six symbols or the zero length preamble having zero symbols.

15. The method of claim 12 further including:
selecting a standard or burst preamble having twenty one symbols when another device indicates to the device a need for longer preambles to remain synchronized.
